(19) United States
(12) Patent Application Publication
(10) Pub. No.: US 2025/0218665 A1
(43) Pub. Date: Jul. 3, 2025

(54) MULTILAYERED CAPACITOR

(71) Applicant: SAMSUNG ELECTRO-MECHANICS CO., LTD., Suwon-si (KR)

(72) Inventors: Seula Park, Suwon-si (KR); Hyunwoong Na, Suwon-si (KR); Kyoungki Min, Suwon-si (KR); Seongmin Park, Suwon-si (KR); Youngkyu Park, Suwon-si (KR); Youngjoon Oh, Suwon-si (KR)

(73) Assignee: SAMSUNG ELECTRO-MECHANICS CO., LTD., Suwon-si (KR)

(21) Appl. No.: 18/912,046

(22) Filed: Oct. 10, 2024

(30) Foreign Application Priority Data
Dec. 28, 2023 (KR) 10-2023-0194174

(51) Int. Cl. H01G 4/008; H01G 4/12; H01G 4/30

(52) U.S. Cl. CPC H01G 4/0085; H01G 4/1227; H01G 4/30

(57) ABSTRACT

The multilayered capacitor according to the present disclosure includes a capacitor body including a dielectric layer and an internal electrode, and an external electrode disposed on an outside surface of the capacitor body,
wherein the internal electrode includes a compound represented by Chemical Formula 1: Mₙ₊₁Xₙ
wherein, in Chemical Formula 1,
M includes at least one selected from the group consisting of Ti, Zr, Hf, Sc, Cr, V, Nb, Ta, Mo, Mn, W, Y, and combinations thereof,
X includes C, N, or a combination thereof, and
1≤n≤2.

### CROSS-REFERENCE TO RELATED APPLICATION

This application claims priority to and the benefit of Korean Patent Application No. 10-2023-0194174 filed in the Korean Intellectual Property Office on Dec. 28, 2023, the entire contents of which are incorporated herein by reference.

### BACKGROUND

The present disclosure relates to a multilayered capacitor.

Recently, as multi-functionalization and miniaturization of electronic devices have been rapidly progressing, miniaturization and performance improvement of electronic components have also been progressing at a rapid pace. Further, the demand for high reliability of electric devices for use in automobiles, network equipment, or the like and electronic components for use in industries has also been increasing significantly.

In order to meet such market demands, competition for technology development of passive components such as inductors, capacitors, or resistors has been accelerating. In particular, great effort has been required to dominate the market by developing various multilayer ceramic capacitor (MLCC) products whose applications and usage as passive components have been continuously increasing.

In addition, a multilayered capacitor is manufactured by stacking dielectric layers and internal electrodes, and is used in various electronic devices such as mobile phones, laptops, and LCD TVs.

With recent technological advancements, multilayered capacitors are required to be miniaturized and have high capacities, and for this purpose, thinning of the internal electrodes is known to be essential.

However, it is known that the thinner the internal electrode is, the lower the electrode connectivity is, which causes a decrease in capacitance, withstand voltage characteristics, and reliability.

### SUMMARY

One aspect of the embodiment provides a multilayered capacitor that can implement thinning of the electrode and has improved electrical characteristics.

However, the problems that the embodiments seek to solve are not limited to the above-described problems and can be expanded in various ways within the scope of the technical ideas included in the embodiments.

A multilayered capacitor according to an embodiment includes a capacitor body including a dielectric layer and an internal electrode, and an external electrode on an outside surface of the capacitor body,
wherein the internal electrode includes a compound represented by Chemical Formula 1.

Mₙ₊₁Xₙ [Chemical Formula 1]

In Chemical Formula 1,
M includes at least one selected from the group consisting of Ti, Zr, Hf, Sc, Cr, V, Nb, Ta, Mo, Mn, W, Y, and combinations thereof,
X includes C, N, or a combination thereof, and
1≤n≤2.

The compound represented by Chemical Formula 1 may include at least one selected from the group consisting of Ti₂C, V₂C, Nb₂C, Mo₂C, Mo₂N, Ti₂N, (Ti_{2-y}Nb_{y})C, (V_{2-y}Nb_{y})C, (Ti_{2-y}V_{y})C, W_{1.33}C, Nb_{1.33}C, Mo_{0.33}C, Mo_{0.33}Y_{0.67}C, and combinations thereof (0<y<2).

The compound represented by Chemical Formula 1 may be a plate-shaped unit Mxene layer, and the internal electrode may include a Mxene laminate in which one or more unit Mxene layers are stacked.

The internal electrode may include a MXene laminate in which 1 to 500 unit MXene layers are stacked.

An average thickness of the internal electrode may be about 0.002 μm to about 2.5 μm.

An average thickness of the dielectric layer may be about 0.5 μm to about 3 μm.

The dielectric layer may include a barium titanate-based compound as a main component, and
the barium titanite-based compound may include at least one selected from the group consisting of BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba₁₋ₓCaₓ)ₘ(Ti_{1-y}Sn_{y})O₃ (0.995≤m≤1.010, 0≤x≤0.10, 0<y≤0.20), and combinations thereof.

The dielectric layer may further include a subcomponent, and
the subcomponent may include at least one selected from the group consisting of dysprosium (Dy), vanadium (V), manganese (Mn), chromium (Cr), silicon (Si), aluminum (Al), magnesium (Mg), tin (Sn), antimony (Sb), and germanium. (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

A multilayered capacitor according to another embodiment includes a capacitor body including a dielectric layer and an internal electrode, and an external electrode disposed on an outside surface of the capacitor body,
wherein the internal electrode may include a compound represented by Chemical Formula 1, and
an average thickness of the internal electrode is about 0.002 μm to about 2.5 μm.

Mₙ₊₁Xₙ [Chemical Formula 1]

In Chemical Formula 1,
M includes at least one selected from the group consisting of Ti, Zr, Hf, Sc, Cr, V, Nb, Ta, Mo, Mn, W, Y, and combinations thereof,
X includes C, N, or a combination thereof, and
1≤n≤2.

The compound represented by Chemical Formula 1 may include at least one selected from the group consisting of Ti₂C, V₂C, Nb₂C, Mo₂C, Mo₂N, Ti₂N, (Ti_{2-y}Nb_{y})C, (V_{2-y}Nb_{y})C, (Ti_{2-y}V_{y})C, W_{1.33}C, Nb_{1.33}C, Mo_{1.33}C, Mo_{1.33}Y_{0.67}C, and combinations thereof (0<y<2).

The compound represented by Chemical Formula 1 may be a plate-shaped unit Mxene layer, and the internal electrode may include a Mxene laminate in which one or more unit Mxene layers are stacked.

The internal electrode may include a MXene laminate in which 1 to 500 unit MXene layers are stacked.

An average thickness of the internal electrode may be about 0.002 μm to about 2.5 μm.

The dielectric layer may include a barium titanate-based compound as a main component, and
the barium titanite-based compound may include at least one selected from the group consisting of BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba₁₋ₓCaₓ)ₘ(Ti_{1-y}Sn_{y})O₃ (0.995≤m≤1.010, 0≤x≤0.10, 0<y≤0.20), and combinations thereof.

The dielectric layer may further include a subcomponent, and
the subcomponent may include at least one selected from the group consisting of dysprosium (Dy), vanadium (V), manganese (Mn), chromium (Cr), silicon (Si), aluminum (Al), magnesium (Mg), tin (Sn), antimony (Sb), and germanium. (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

The multilayered capacitor according to the embodiments may have an advantage that a thinner electrode can be obtained and electrical characteristics can be improved.

However, the various and beneficial advantages and effects of the present disclosure are not limited to the above-described descriptions, and may be more easily understood in the process of explaining specific embodiments of the present disclosure.

### BRIEF DESCRIPTION OF THE DRAWINGS

FIG. 1 is a perspective view showing a multilayered capacitor according to an embodiment.

FIG. 2 is a cross-sectional view of the multilayered capacitor taken along line I-I′ of FIG. 1.

FIG. 3 is an exploded perspective view showing the stacked structure of internal electrodes in the capacitor body of FIG. 1.

FIG. 4 is a schematic view showing a portion of the cross section of a multilayered capacitor according to an embodiment.

FIG. 5 is a graph evaluating the impedance of the multilayered capacitors according to Example 1 and Comparative Example 1.

### DETAILED DESCRIPTION OF THE EMBODIMENTS

Hereinafter, exemplary embodiments of the present disclosure will be described in detail with reference to the accompanying drawings such that those skilled in the art can easily implement them. The drawings and description are to be regarded as illustrative in nature and not restrictive. Like reference numerals designate like elements throughout the specification. Further, the accompanying drawings are provided for helping to easily understand exemplary embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

When a constituent element is referred to as being “connected” or “coupled” to another constituent element, it will be appreciated that it may be directly connected or coupled to the other constituent element, or face the other constituent element, or intervening other constituent elements may be present. In contrast, when a constituent element is referred to as being “directly connected” or “directly coupled” to another constituent element, it will be appreciated that there are no intervening other constituent elements present.

In the present specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Accordingly, unless explicitly described to the contrary, the word “comprise,” and variations such as “comprises” or “comprising,” will be understood to imply the inclusion of stated elements but not the exclusion of any other elements.

The term “about,” as used herein, means approximately. In general, the term “about” is used herein to modify a numerical value above and below the stated value by a variance of 10%. In one aspect, the term “about” means plus or minus 20% of the numerical value of the number with which it is being used.

In the present disclosure, “main component” means: an amount (content) of a barium titanate-based compound is 50 to 100 wt %, 60 to 100 wt %, 70 to 100 wt %, 80 to 100 wt %, 90 to 100 wt %, or substantially 100 wt % based on a total amount a dielectric layer.

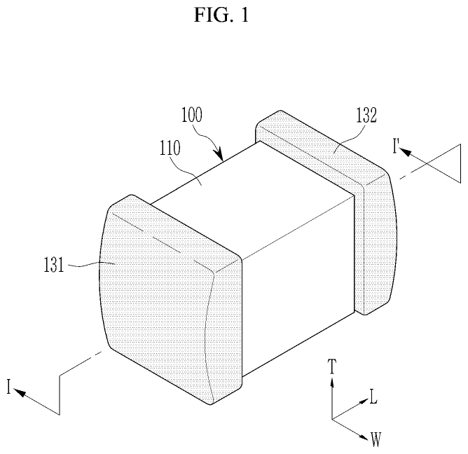

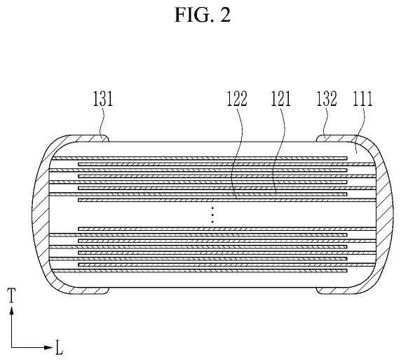

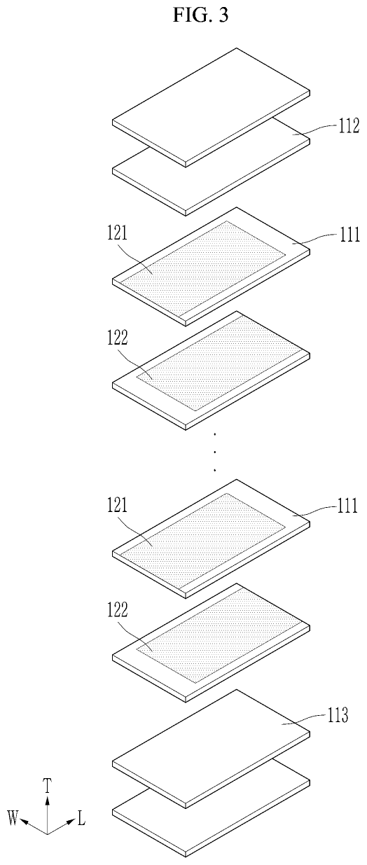

FIG. 1 is a perspective view showing a multilayered capacitor 100 according to some embodiments of the disclosure, FIG. 2 is a cross-sectional view of the multilayered capacitor 100 taken along line I-I′ of FIG. 1, and FIG. 3 is an exploded perspective view showing the stacked structure of internal electrodes in the capacitor body 110 of FIG. 1.

To clearly describe the present embodiment, directions are defined as follow: the L axis, the W axis, and the T axis shown in the drawings represent the longitudinal direction, width direction, and thickness direction of the capacitor body 110, respectively. Herein, the thickness direction (T-axis direction) may be a direction perpendicular to wide surfaces (main surfaces) of plate-shaped constituent elements, and may be used, for example, as the same concept as the stacking direction in which dielectric layers 111 are stacked. The longitudinal direction (L-axis direction) may be a direction extending in parallel with the wide surfaces (main surfaces) of the plate-shaped constituent elements and be a direction appropriately perpendicular to the thickness direction (T-axis direction), and may be, for example, a direction in which a first external electrode 131 and a second external electrode 132 are positioned on both sides. The width direction (W-axis direction) may be a direction extending in parallel with the wide surfaces (main surfaces) of the plate-shaped constituent elements and be a direction appropriately perpendicular to the thickness direction (T-axis direction) and the longitudinal direction (L-axis direction), and the lengths of the plate-shaped constituent elements in the longitudinal direction (L-axis direction) may be longer than their lengths in the width direction (W-axis direction).

Referring to FIGS. 1 to 3, the multilayered capacitor 100 according to the embodiment may include the capacitor body 110, and the first external electrode 131 and the second external electrode 132 that are disposed on both ends of the capacitor body 110 facing each other in the longitudinal direction (L-axis direction).

The capacitor body 110 may have, for example, an approximate hexahedral shape.

In the present embodiment, for ease of explanation, in the capacitor body 110, two surfaces facing each other in the thickness direction (T-axis direction) are defined as a first surface and a second surface, and two surfaces that are coupled to the first surface and the second surface and face each other in the longitudinal direction (L-axis direction) are defined as a third surface and a fourth surface, and two surfaces that are coupled to the first surface and the second surface, are coupled to the third surface and the fourth surface, and face each other in the width direction (W-axis direction) are defined as a fifth surface and a sixth surface.

According to some embodiments, the first surface which is the lower surface may be a surface oriented to the mounting direction. Further, the first surface to the sixth surface may be flat; however, the present exemplary embodiment is not limited thereto, and for example, the first surface to the sixth surface may be curved surfaces with convex center portions, and the border of each surface, i.e., the edge may be rounded.

The shape and dimensions of the capacitor body 110 and the number of dielectric layers 111 that are stacked are not limited to those shown in the drawings of the present example embodiment.

The capacitor body 110 may be formed by stacking a plurality of dielectric layers 111 in the thickness direction (T-axis direction) and sintering them, and includes the plurality of dielectric layers 111, and first internal electrodes 121 and second internal electrodes 122 that are alternately disposed in the thickness direction (T-axis direction) with the dielectric layers 111 interposed therebetween.

In this case, adjacent dielectric layers 111 in the capacitor body 110 may be so integrated that it is difficult to see the boundaries between the dielectric layers without the use of a scanning electron microscope (SEM).

Further, the capacitor body 110 may include an active region and cover regions 112 and 113.

The active region is a portion that contributes to the formation of the capacitance of the multilayered capacitor 100. As an example, the active region may be the region where the first internal electrodes 121 and the second internal electrodes 122 that are stacked along the thickness direction (T-axis direction) overlap.

The cover regions 112 and 113 are margin portions in the thickness direction, and may be positioned on the first surface side and second surface side of the active region in the thickness direction (T-axis direction). These cover regions 112 and 113 may be stacked on the upper surface and lower surface of the active region, respectively, and each may consist of a single dielectric layer 111 or two or more dielectric layers 111.

Additionally, the capacitor body 110 may further include a side cover region. The side cover regions are margin portions in the width direction, and may be positioned on the fifth surface side and sixth surface side of the active region in the width direction (W-axis direction), respectively. These side cover regions may be formed by stacking dielectric green sheets with conductive paste layers for forming internal electrode and sintering them. When the conductive paste layers are formed on the surfaces of the dielectric green sheets, the conductive paste may be coated only on some portions of the surfaces of the dielectric green sheets and may not be coated on both side surfaces of the surfaces of the dielectric green sheets,

The cover regions 112 and 113 and the side cover regions may serve to prevent damage to the first internal electrodes 121 and the second internal electrodes 122 by physical or chemical stress.

The multilayered capacitor 100 according to some embodiments includes a capacitor body 110 including a dielectric layer 111 and internal electrodes 121 and 122, and external electrodes 131 and 132 disposed on an outside surface of the capacitor body 110.

Hereinafter, the multilayered capacitor 100 will be described in detail with reference to the drawings.

### Internal Electrode

The first internal electrodes 121 and the second internal electrodes 122 are electrodes with different polarities, and may be alternately disposed along the T-axis direction such that a first internal electrode and a second internal electrode adjacent to each other with a dielectric layer 111 interposed therebetween face each other, and one end of each internal electrode may be exposed from the third and fourth surfaces of the capacitor body 110.

The first internal electrodes 121 and the second internal electrodes 122 may be electrically insulated from each other by the dielectric layers 111 disposed therebetween.

The end portions of the first internal electrodes 121 and the second internal electrodes 122 that are alternately exposed from the third and fourth surfaces of the capacitor body 110 may be electrically coupled to the first external electrode 131 and the second external electrode 132, respectively.

In an embodiment, the internal electrodes 121 and 122 include a compound represented by Chemical Formula 1.

Mₙ₊₁Xₙ [Chemical Formula 1]

In Chemical Formula 1,
M includes at least one selected from the group consisting of Ti, Zr, Hf, Sc, Cr, V, Nb, Ta, Mo, Mn, W, Y, and combinations thereof,
X includes C, N, or a combination thereof, and
1≤n≤2.

According to some embodiments, the compound represented by Chemical Formula 1 may include at least one selected from the group consisting of Ti₂C, V₂C, Nb₂C, Mo₂C, Mo₂N, Ti₂N, (Ti_{2-y}Nb_{y})C, (V_{2-y}Nb_{y})C, (Ti_{2-y}V_{y})C, W_{1.33}C, Nb_{1.33}C, Mo_{1.33}C, Mo_{1.33}Y_{0.67}C, and combinations thereof (0<y<2).

According to some embodiments, the compound represented by Chemical Formula 1 may be a Mxene compound. The MXene compound is a two-dimensional material and may be a non-magnetic compound with excellent electrical conductivity and strength.

The MXene compound, which is a non-magnetic material and has low magnetic permeability, if applied to the internal electrodes 121 and 122, may reduce equivalent series inductance (ESL) of the multilayered capacitor 100 and thus improve impedance characteristics in a high frequency region.

In addition, because the MXene compound is very thin with a unit thickness of several nm (e.g., about 2 nm or less) and a two-dimensional material, a shrinkage of the multilayered capacitor may be activated in the T-axis direction rather than the L-axis and W-axis directions during the sintering process. Accordingly, if the MXene compound is applied to the internal electrodes 121 and 122, thinning of the electrodes may be achieved. Accordingly, design freedom of the capacitor may be secured, realizing ultra-small but high-capacitance multilayered capacitor 100.

According to some embodiments of the present disclosure, the Mxene compound represented by Chemical Formula 1 may be a compound obtained from a MAX phase compound represented by Chemical Formula 2.

Mₙ₊₁AXₙ [Chemical Formula 2]

In Chemical Formula 2,
M includes at least one selected from the group consisting of Ti, Zr, Hf, Sc, Cr, V, Nb, Ta, Mo, Mn, W, Y, and combinations thereof,
A includes at least one selected from the group consisting of Al, Ga, In, Tl, Si, Ge, Sn, Pb, Zn, Cd, P, As, S, Cu, Au, and combinations thereof,
X includes C, N, or a combination thereof, and
n is an integer of 1 to 4.

The Max phase compound is a compound that has both metallic and ceramic properties, and is characterized by excellent thermal and electrical conductivity, and high strength, and modulus.

The Max phase compound represented by Chemical Formula 2 may include at least one selected from the group consisting of Ti₂AlC, V₂AlC, Cr₂AlC, Nb₂AlC, Ta₂AlC, Zr₂AlC, Ti₂AlN, Ti₃AlC₂, V₃AlC₂, Ta₃AlC₂, Zr₃AlC₂, Ti₄AlN₃, V₄AlC₃, Nb₄AlC₃, Ta₄AlC₃, (Mo,V)₄AlC₃, Mo₄VAlC₄, Ti₃SiC₂, Ti₄SiC₃, Ti₂CdC, Sc₂InC, Sc₂SnC, Ti₂GaC, Ti₂InC, Ti₂TlC, V₂GaC, Cr₂GaC, Ti₂GaN, Ti₂InN, V₂GaN, Cr₂GaN, Ti₂GeC, Ti₂SnC, Ti₂PbC, V₂GeC, Cr₂GeC, V₂PC, V₂AsC, Ti₂SC, Zr₂InC, Zr₂TlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂GaC, Hf₂SnC, Hf₂PbC, Hf₂SnN, Hf₂SC, Ti₂ZnC, Ti₂ZnN, V₂ZnC, Nb₂CuC, Mn₂GaC, Mo₂AuC, Ti₂AuN, Ti₃GaC₂, Ti₃InC₂, Ti₃GeC₂, Ti₃SnC₂, Ti₃ZnC₂, Ti₄GaC₃, Ti₄GeC₃, and combinations thereof.

According to some embodiments, the internal electrodes 121 and 122 may further include a conductive metal, and the conductive metal may further include a metal such as Ni, Cu, Ag, Pd, or Au, or an alloy thereof, such as an Ag—Pd alloy.

Also, the first internal electrodes 121 and the second internal electrodes 122 may include dielectric particles of the same composition system as that of the ceramic material included in the dielectric layers 111.

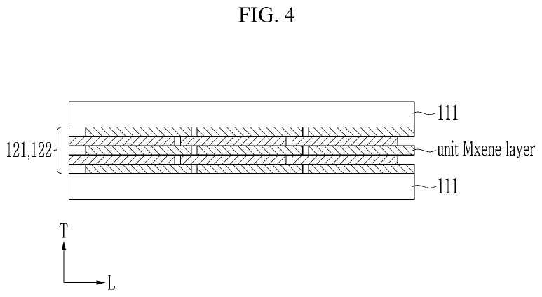

FIG. 4 is a schematic view showing a portion of the cross section of the multilayered capacitor 100 according to some embodiments of the present disclosure.

Referring to FIG. 4, the compound represented by Chemical Formula 1 may have a layered structure and may be stacked in one or more layers to form the internal electrodes 121 and 122.

According to some embodiments, the compound represented by Chemical Formula 1 may be a plate-shaped unit MXene layer, and the internal electrodes 121 and 122 may include a MXene laminate in which one or more unit MXene layers are stacked. The unit MXenes are stacked in the T-axis direction of the capacitor body 110, but may be stacked so that an overlapping area between each unit MXene layer may be non-uniform. As an example, the unit MXene layer may be connected continuously or discontinuously in the L-axis direction of the capacitor body 110.

According to some embodiments, the compound (unit MXene layer) represented by Chemical Formula 1 may be stacked in one layer (single layer) or more, for example, 2 or more layers, 10 or more layers, 20 or more layers, 100 or more layers, or 350 or more layers. The upper limit of the number of layers is not particularly limited, but may be, for example, 500 layers or less.

According to some embodiments, average thicknesses of the internal electrodes 121 and 122 may be greater than or equal to about 0.002 μm, greater than or equal to about 0.01 μm, greater than or equal to about 0.05 μm, greater than or equal to about 0.1 am, or greater than or equal to about 0.5 μm, and less than or equal to about 2.5 μm, less than or equal to about 2 μm, less than or equal to about 1.5 μm, or less than or equal to about 1 μm. As described above, thinning of the internal electrodes 121 and 122 can be achieved by applying Mxene compound, which is a compound represented by Chemical Formula 1, to the internal electrodes 121 and 122.

The average thicknesses of the internal electrodes 121 and 122 can be measured by the following method.

First, the multilayered capacitor 100 is placed in an epoxy mixture and cured, and the L-axis and T-axis direction sides of the capacitor body 110 are polished to ½ the point in a W-axis direction, then placed in a vacuum atmosphere chamber, and then, cut in the L-axis direction and the T-axis direction from the center of the W-axis direction of the capacitor body 110 to prepare a cross-sectional sample (hereinafter referred to as “cross-sectional sample”).

It may be an arithmetic mean value of the thicknesses of the first internal electrode 121 or second internal electrode 122 at 10 points spaced at predetermined intervals from a reference point in the scanning electron microscope (SEM) of the cross-sectional sample, when the center point in the longitudinal direction (L-axis direction) or width direction (W-axis direction) of the first internal electrode 121 or second internal electrode 122 is used as a reference point.

The intervals between the 10 points may be adjusted according to the scale of the SEM image. In this case, all 10 points should be located within the first internal electrode 121 or the second internal electrode layer 122, and when all 10 points are not located within the first internal electrode 121 or the second internal electrode layer 122, the position of the reference point may be changed or the interval of 10 points may be adjusted.

The stacked structure and constituent elements of the internal electrodes 121 and 122 including the aforementioned compound represented by Chemical Formula 1 may be confirmed by the following method.

In the scanning electron microscope (SEM) image of the cross-sectional sample, internal electrodes 121 and 122 may be in the form of plate-shaped unit MXene layers stacked in a plate shape.

Additionally, through SEM-EDS analysis, it is confirmed that the elements constituting the internal electrodes 121 and 122 are elements constituting the MXene compound (e.g., Ti, C, etc.).

### Dielectric Laver

The dielectric layer 111 includes a dielectric composition, and the dielectric composition may include a main component and a subcomponent.

The main component is the parent material of the dielectric, has a high dielectric constant, and contributes to the formation of the dielectric constant of the multilayered capacitor 100.

According to some embodiments, the main component may include a barium titanite-based compound, and the barium titanite-based compound may be a dielectric material including at least one selected from the group consisting of BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba₁₋ₓCaₓ)ₘ(Ti_{1-y}Sn_{y})O₃ (0.995≤m≤1.010, 0≤x≤0.10, 0<y≤0.20), and combinations thereof.

For example, the main component may include BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

According to some embodiments, the subcomponent may include at least one selected from the group consisting of dysprosium (Dy), vanadium (V), manganese (Mn), chromium (Cr), silicon (Si), aluminum (Al), magnesium (Mg), tin (Sn), antimony (Sb), and germanium. (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

The dielectric may further include a ceramic additive, an organic solvent, a binder, a dispersant, or a combination thereof.

According to some embodiments, an average thickness of the dielectric layer 111 may be greater than or equal to about 0.5 μm, greater than or equal to about 1.0 μm, or greater than or equal to about 2.0 μm, and less than or equal to about 3 am, less than or equal to about 2.9 μm, less than or equal to about 2.8 μm, or less than or equal to about 2.7 μm.

During the sintering process of the capacitor body, shrinkage of the MXene compound included in the internal electrodes 121 and 122 in the T-axis direction may be activated, while shrinkage in the L-axis direction and W-axis direction may be suppressed. Accordingly, shrinkage of the dielectric layer 111 in the L-axis direction and W-axis direction can be suppressed, and as shrinkage in the T-axis direction of the dielectric layer 111 is activated, the thickness of the dielectric layer 111 can also be thinned.

The average thickness of the dielectric layer 111 may be measured by the following method.

First, a scanning electron microscope (SEM) image obtained by observing a cross-sectional sample with a scanning electron microscope is prepared.

It may be an arithmetic mean value of the thicknesses of the dielectric layer 111 at 10 points spaced at predetermined intervals from a reference point in the SEM image of the cross-sectional sample, when the center point in the longitudinal direction (L-axis direction) or width direction (W-axis direction) of dielectric layer 111 is used as a reference point.

The intervals between the 10 points may be adjusted according to the scale of the SEM image. In this case, all 10 points should be located within the dielectric layers 111, and when all 10 points are not located within the dielectric layers 111, the position of the reference point may be changed or the interval of 10 points may be adjusted.

### External Electrode

The first external electrode 131 and the second external electrode 132 are provided with voltages with different polarity and respectively connected electrically to each exposed portion of the first internal electrode 121 and the second internal electrode 122.

According to the above configuration, if a predetermined voltage is applied to the first external electrode 131 and the second external electrode 132, charges are accumulated between the first internal electrode 121 and the second internal electrode 122 facing each other. Herein, the multilayered capacitor 100 may have proportional capacitance to an area where the first internal electrode 121 and the second internal electrode 122 are overlapped each other along a T-axis direction in the active region.

The first external electrode 131 and the second external electrode 132 may be disposed on the third and fourth surfaces of the capacitor body 110, respectively, and may include first and second connection portions, respectively, that are coupled to the first internal electrodes 121 and the second internal electrodes 122, respectively, and include first and second band portions, respectively, that are disposed at the edges where the third and fourth surfaces of the capacitor body 110 meet either the first and second surfaces or the fifth and sixth surfaces.

The first and second band portions may extend from the first and second connection portions to some points of either the first and second surfaces or fifth and sixth surfaces of the capacitor body 110. The first and second band portions may serve to improve the adhesion strength of the first external electrode 131 and the second external electrode 132.

According to some embodiments, each of the first external electrode 131 and the second external electrode 132 may include a sintered metal layer that is in contact with the capacitor body 110, a conductive resin layer that is disposed to cover the sintered metal layer, and a plating layer that is disposed to cover the conductive resin layer.

The sintered metal layer may include a conductive metal and glass.

According to some embodiments, the sintered metal layer may include, as the conductive metal, at least one selected from the group consisting of copper (Cu), nickel (Ni), silver (Ag), palladium (Pd), gold (Au), platinum (Pt), tin (Sn), tungsten (W), titanium (Ti), lead (Pb), an alloy thereof, and combinations thereof, and for example, copper (Cu) may include a copper (Cu) alloy. When the conductive metal includes copper, metals other than copper may be included in the amount of less than or equal to about 5 parts by mole based on 100 parts by mole of copper.

According to some embodiments, the sintered metal layer may include a composition including oxides as glass, and may include, for example, one or more selected from silicon oxides, boron oxides, aluminum oxides, transition metal oxides, alkali metal oxides, and alkaline earth metal oxides. The transition metal may be selected from zinc (Zn), titanium (Ti), copper (Cu), vanadium (V), manganese (Mn), iron (Fe), and nickel (Ni), and the alkali metal may be selected from lithium (Li), sodium (Na), and potassium (K), and the alkaline earth metal may be one or more selected from magnesium (Mg), calcium (Ca), strontium (Sr), and barium (Ba).

Optionally, the conductive resin layer is formed on the sintered metal layer, and for example, may be formed to completely cover the sintered metal layer. Meanwhile, the first external electrode 131 and the second external electrode 132 may not include a sintered metal layer, and in this case, the conductive resin layer may be in direct contact with the capacitor body 110.

The conductive resin layers may extend to the first and second surfaces or fifth and sixth surfaces of the capacitor body 110, and the lengths of regions (i.e., band portions) where the conductive resin layers extend to the first and second surfaces or fifth and sixth surfaces of the capacitor body 110 may be longer than the lengths of regions (i.e., band portions) where the sintered metal layers extend in the first and second surfaces or fifth and sixth surfaces of the capacitor body 110. In other words, the conductive resin layers may be formed on the sintered metal layers, and may be formed so as to completely cover the sintered metal layers.

The conductive resin layers include a resin and a conductive metal.

The resin which is included in the conductive resin layers is not particularly limited as long as it has a bonding property and an impact absorption property and can be mixed with conductive metal powder to form a paste, and may include, for example, a phenolic resin, an acrylic resin, a silicon resin, an epoxy resin, or a polyimide resin.

The conductive metal that is included in the conductive resin layers serves to electrically connect the conductive resin layers to the first internal electrode 121 and the second internal electrode 122, or the sintered metal layer.

The conductive metal that is included in the conductive resin layer may have a spherical shape, a flake shape, or a combination thereof. In other words, the conductive metal may be formed only in a flake shape, or may be formed only in a spherical shape, or may be the form of a mixture of a flake shape and a spherical shape.

Herein, the spherical shape may include a shape which is not completely spherical, and may include, for example, a shape in which a ratio of the length of the major axis to the length of the minor axis (major axis/minor axis) may be less than or equal to about 1.45. The flake-type powder refers to a powder with a flat and elongated shape, and is not particularly limited, but for example, a ratio of the length of the major axis to the length of the minor axis (major axis/minor axis) may be greater than or equal to about 1.95.

The first external electrode 131 and the second external electrode 132 may further include a plating layer disposed on an outside surface of the conductive resin layer.

The plating layer may include at least one selected from the group consisting of nickel (Ni), copper (Cu), tin (Sn), palladium (Pd), platinum (Pt), gold (Au), silver (Ag), tungsten (W), titanium (Ti), lead (Pb) and alloys thereof. According to some embodiments, each plating layer may be a nickel (Ni) plating layer or a tin (Sn) plating layer, or may be a form in which a nickel (Ni) plating layer and a tin (Sn) plating layer are sequentially stacked, or may be a form in which a tin (Sn) plating layer, a nickel (Ni) plating layer, and a tin (Sn) plating layer are sequentially stacked. Alternatively, each plating layer may include a plurality of nickel (Ni) plating layers and/or a plurality of tin (Sn) plating layers.

The plating layer can improve mountability to the substrate, structural reliability, durability to the outside, heat resistance, and equivalent series resistance (ESR) of the multilayered capacitor 100.

### Method of Manufacturing Multilayered Capacitor

A method of manufacturing the multilayered capacitor according to another embodiment includes manufacturing a capacitor body including a dielectric layer and an internal electrode and then, forming an external electrode on the outside surface of the capacitor body.

First, the manufacturing the capacitor body is illustrated.

In the manufacturing process of the capacitor body, a dielectric paste, which will be formed into a dielectric layer after sintering, and a conductive paste, which will be formed into an internal electrode after the sintering, are prepared.

The dielectric paste is, for example, prepared in the following method. Dielectric powders are uniformly mixed through wet mixing and the like, dried, and heat-treated under predetermined conditions obtain plasticized powder. Subsequently, an organic vehicle or an aqueous vehicle is added to the plasticized powder and additionally, kneaded to prepare the dielectric paste.

The obtained dielectric paste is formed into a dielectric green sheet by using a technique such as the doctor blade method. Additionally, the dielectric paste may include additives selected from various dispersants, plasticizers, dielectrics, subcomponent compounds, or glass, if necessary.

The conductive paste for an internal electrode can be prepared by including the MXene compound represented by Chemical Formula 1. Since the MXene compound represented by Chemical Formula 1 has been described above, its description is omitted here.

According to some embodiments, the conductive paste for an internal electrode can be coated on the surface of the dielectric green sheet in a predetermined pattern using various printing methods such as screen printing or transfer methods. According to some embodiments, a conductive paste for an internal electrode can be coated on the surface of the dielectric green sheet through a coating process such as spin coating or spray coating.

Subsequently, the dielectric green sheets with the internal electrode pattern in plural are stacked and then, pressed in a stacking direction to obtain a dielectric green sheet laminate. Herein, the internal electrode patterns may be stacked so that the dielectric green sheet laminate may have a dielectric green sheet at the top and at the bottom in the stacking direction.

Optionally, the obtained dielectric green sheet laminate may be cut into a predetermined size by dicing or the like.

In addition, the dielectric green sheet laminate, if necessary, may be solidified and dried to remove the plasticizer and the like and then, barrel-polished by using a horizontal centrifugal barrel machine, etc. In the barrel-polishing, unnecessary parts such as burrs, etc., which are generated during the cutting, may be polished by inserting the dielectric green sheet laminate with media and a polishing solution into a barrel container and then, applying rotational motion, vibration, or the like to the barrel container. In addition, after the barrel-polishing, the dielectric green sheet laminate may be washed with a cleaning solution such as water and the like and dried.

The dielectric green sheet laminate is subjected to binder removal and sintering treatments to obtain a capacitor body.

The binder removal treatment may be performed under conditions appropriately adjusted according to a main component composition of the dielectric layer and a main component composition of the internal electrode. For example, the binder removal treatment may be performed by increasing a temperature at about 5° C./hour to about 300° C./hour and maintained at a support temperature of about 180° C. to about 400° C. for about 0.5 hour to about 24 hours. The binder removal is performed under an air or reducing atmosphere.

The sintering treatment may be performed under conditions appropriately adjusted according to a main component composition of the dielectric layer or a main component composition of the internal electrode. According to some embodiments, the sintering treatment may be performed at about 1200° C. to about 1350° C. or about 1220° C. to about 1300° C. for about 0.5 hour to about 8 hours or about 1 hour to about 3 hours. The sintering treatment is performed under a reducing atmosphere, for example, under an atmosphere in which a mixed gas of nitrogen gas (N₂) and hydrogen gas (H₂) is humidified.

After the sintering treatment, annealing may be performed. Because the annealing is a treatment to reoxidize the dielectric layer, if the sintering is performed under the reducing atmosphere, the annealing may be performed. The annealing treatment may be performed under conditions appropriately adjusted according to a main component composition of the dielectric layer and the like. For example, the annealing treatment may be performed at about 950° C. to about 1150° C. for about 0 hour to about 20 hours at about 50° C./hour to about 500° C./hour. In addition, the annealing may be performed under a humidified nitrogen gas (N₂) atmosphere at an oxygen partial pressure of about 1.0×10⁻⁹ MPa to about 1.0×10⁻⁵ MPa.

The humidifying nitrogen gas, mixed gas, or the like in the binder removal treatment, the sintering treatment, or the annealing treatment may be performed, for example, by using a wetter and the like, wherein a temperature of water used therein may be at about 5° C. to about 75° C. The binder removal treatment, the sintering treatment, and the annealing treatment may be performed sequentially or independently.

Optionally, the third and fourth surfaces of the capacitor body may be subjected to surface treatment such as sand blasting, laser irradiation, or barrel polishing. This surface treatment may expose ends of the first and second internal electrodes onto the outermost surfaces of the third and fourth surfaces, which may solidify electrical bonding between the first and second external electrodes and the first and second internal electrodes and easily forming alloy portions.

Subsequently, a paste for forming a sintered metal layer is coated on the outside of the obtained capacitor body and sintered to form sintered metal layers as the external electrodes.

The paste for forming a sintered metal layer may include a conductive metal and glass. The conductive metal and the glass are the same as aforementioned above and thus will not be repetitively mentioned. In addition, the paste for forming a sintered metal layer may optionally include a subcomponent such as a binder, solvent, dispersant, plasticizer, or oxide powder. For example, the binder may be ethylcellulose, acrylic, or butyral, and the solvent may be an organic solvent such as terpineol, butyl carbitol, alcohol, methyl ethyl ketone, acetone, or toluene, or an aqueous solvent.

A method of coating the paste for forming a sintered metal layer on the outside surface of the capacitor body may include dipping, various printings such as screen printing and the like, coating by using a dispenser, etc., spraying using a spray, and the like. The paste for forming a sintered metal layer may be coated at least on the third and fourth surfaces of the capacitor body and optionally, each portion of the first surface, the second surface, the fifth surface, or the sixth surface where band portions of the first and second external electrodes may be formed.

Subsequently, the capacitor body, which is coated with the paste for forming a sintered metal layer, is dried and sintered at about 700° C. to about 1000° C. for about 0.1 hour to about 3 hours to form the sintered metal layers.

Optionally, on the outside surface of the obtained capacitor body, a paste for forming a conductive resin layer may be coated and cured to form a conductive resin layer.

The paste for forming the conductive resin layer may include a resin and, optionally, a conductive metal or a non-conductive filler. Because the descriptions of the conductive metal and resin are the same as described above, repetitive description will be omitted. Additionally, the paste for forming the conductive resin layer may optionally include a subcomponent such as a binder, solvent, dispersant, plasticizer, or oxide powder. For example, the binder may be ethylcellulose, acrylic, or butyral, and the solvent may be an organic solvent such as terpineol, butyl carbitol, alcohol, methyl ethyl ketone, acetone, or toluene, or an aqueous solvent.

According to some embodiments, a method of forming the conductive resin layer may include dipping the capacitor body 110 in the paste for forming a conductive resin layer and curing it, or printing the paste for forming a conductive resin layer on the surface of the capacitor body 110 in screen printing, gravure printing, etc. or coating and coating the paste for forming a conductive resin layer on the surface of the capacitor body 110 and then, curing it.

Subsequently, the plating layer may be formed on the outside surface of the conductive resin layer.

According to some embodiments, the plating layer may be formed in a plating method, for example, by sputtering or electric deposition.

Hereinafter, specific examples of the present disclosure will be presented. However, the following examples are intended only to specifically illustrate or describe the present disclosure, and should not be construed as limiting the scope of the present disclosure.

### EXAMPLES

### Example 1

A 4 μm-thick dielectric green sheet was prepared by preparing dielectric slurry including BaTiO₃ and then, coating the dielectric slurry with a head discharge-type on-roll coater

Subsequently, a conductive paste for an internal electrode including Ti₂C was prepared.

The conductive paste was printed to be 2 μm thick (Ti₂C 350 layer) on the dielectric green sheet surface, and more than one dielectric green sheet with a conductive paste layer were stacked and compressed to manufacture a dielectric green sheet laminate.

The dielectric green sheet laminate was plasticized at 400° C. or less under a nitrogen atmosphere and sintered at 1300° C. or less at a hydrogen (H₂) concentration of 1.0% or less to manufacture a multilayered capacitor according to Example 1.

### Example 2

A multilayered capacitor of Example 2 was manufactured in the same manner as in Example 1 except that the conductive paste was printed to be 1 μm thick (Ti₂C 145 layer) on the dielectric green sheet surface.

### Example 3

A multilayered capacitor of Example 3 was manufactured in the same manner as in Example 1 except that the conductive paste was printed to be 0.2 μm thick (Ti₂C 24 layer) on the dielectric green sheet surface.

### Example 4

A multilayered capacitor of Example 4 was manufactured in the same manner as in Example 1 except that the conductive paste was printed to be 0.005 μm thick (Ti₂C 1 layer) on the dielectric green sheet surface.

### Comparative Example 1

A 4 μm-thick dielectric green sheet was prepared by preparing slurry for a dielectric including BaTiO₃ and coating it with a head discharge-type on-roll coater. Subsequently, a conductive paste for an internal electrode including Ni was prepared.

The conductive paste was printed to be 4 μm thick on the dielectric green sheet surface, and more than one dielectric green sheet with a conductive paste layer were stacked and compressed to manufacture a dielectric green sheet laminate.

The dielectric green sheet laminate was plasticized at 400° C. or less under a nitrogen atmosphere and sintered at 1300° C. or less at a hydrogen (H₂) concentration of 1.0% or less to manufacture a multilayered capacitor according to Comparative Example 1.

### Comparative Example 2

A multilayered capacitor of Comparative Example 2 was manufactured in the same manner as in Comparative Example 1 except that the conductive paste was printed to be 3 μm thick on the dielectric green sheet surface.

### Comparative Example 3

A multilayered capacitor of Comparative Example 3 was manufactured in the same manner as in Comparative Example 1 except that the conductive paste was printed to be 2 μm thick on the dielectric green sheet surface.

### Comparative Example 4

A multilayered capacitor of Comparative Example 4 was manufactured in the same manner as in Comparative Example 1 except that the conductive paste was printed to be 1 μm thick on the dielectric green sheet surface.

### EVALUATION EXAMPLES

### Evaluation Example 1: Thickness Evaluation of Internal Electrode and Dielectric Layer

The multilayered capacitors according to Example 1 and Comparative Example 1 were measured with respect to a thickness of each internal electrode and each dielectric layer as follows.

First of all, the multilayered capacitors were placed and cured in an epoxy mixing solution, and L-axis direction and T-axis direction surfaces of each capacitor body were polished to ½ the point in the W-axis direction, fixed, maintained in a vacuum atmosphere chamber, and cut at the center of the W axis direction in the L-axis and T-axis directions to prepare cross-sectional samples (hereinafter, referred to as “cross-sectional samples”).

The average thickness of the internal electrode an arithmetic mean value of the thicknesses of the internal electrodes at 10 points spaced at predetermined intervals from a reference point in the SEM image of the cross-sectional sample, when the center point in the L-axis direction or W-axis direction of the internal electrode was used as a reference point.

The average thickness of the internal electrode an arithmetic mean value of the thicknesses of the dielectric layers at 10 points spaced at predetermined intervals from a reference point in the SEM image of the cross-sectional sample, when the center point in the L-axis direction or W-axis direction of the dielectric layer was used as a reference point.

TABLE 1

| | | Printing thickness | Average thickness of | Average thickness of |
|---|---|---|---|---|
| | Composition | of internal | internal electrode | dielectric layer |
| | of internal | electrode | after sintering | after sintering |
| | electrode | (μm) | (μm) | (μm) |
| Comp. Ex. 1 | Ni | 4 | 2.9 | 3.2 |
| Comp. Ex. 2 | | 3 | 2 | 3.4 |
| Comp. Ex. 3 | | 2 | 1.5 | 3.5 |
| Comp. Ex. 4 | | 1 | 0.7 | 3.5 |
| Ex. 1 | Ti₂C | 2 | 0.7 | 2.8 |
| Ex. 2 | | 1 | 0.29 | 2.7 |
| Ex. 3 | | 0.2 | 0.055 | 2.9 |
| Ex. 4 | | 0.005 | 0.002 | 2.9 |

Referring to Table 1, the multilayered capacitors of Examples 1 to 4 in which Ti₂C, an MXene compound, was applied to internal electrodes, were thinner than those of Comparative Examples 1 to 4.

In addition, in the multilayered capacitors of the examples, whose shrinkage was activated in the T-axis direction of the internal electrodes and the dielectric layer, even though their dielectric green sheets with the same thickness as that of those of the comparative examples were sintered, their dielectric layers have a relatively thin average thickness after the sintering.

### Evaluation Example 2: Evaluation of High-frequency Region Impedance Characteristics

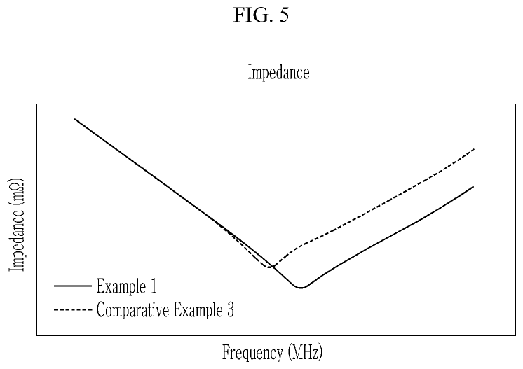

The multilayered capacitors of Example 1 and Comparative Example 3 were evaluated with respect to impedance characteristics in a high frequency region, and the results are shown in FIG. 5.

The multilayered capacitor of Comparative Example 3 exhibited large ESL and low resonance frequency due to high permeability of Ni used in the internal electrodes.

On the other hand, the multilayered capacitor of Example 1 exhibited reduced ESL and improved impedance characteristics in the high frequency region due to low permeability of the MXene compound used in the internal electrodes.

While this disclosure has been described in connection with what is presently considered to be practical exemplary embodiments, it is to be understood that the present disclosure is not limited to the disclosed exemplary embodiments. On the contrary, it is intended to cover various modifications and equivalent arrangements included within the spirit and scope of the appended claims.

### DESCRIPTION OF SYMBOLS

100: multilayered capacitor
110: capacitor body
111: dielectric layer
112, 113: cover region
121: first internal electrode
122: second internal electrode
131: first external electrode
132: second external electrode

What is claimed is:

1. A multilayered capacitor, comprising
a capacitor body including a dielectric layer and an internal electrode, and an external electrode disposed on an outside surface of the capacitor body,
wherein the internal electrode includes a compound represented by Chemical Formula 1:
Mₙ₊₁Xₙ [Chemical Formula 1]
wherein, in Chemical Formula 1,
M includes at least one selected from the group consisting of Ti, Zr, Hf, Sc, Cr, V, Nb, Ta, Mo, Mn, W, Y, and combinations thereof,
X includes C, N, or a combination thereof, and
1≤n≤2.

2. The multilayered capacitor of claim 1, wherein
the compound represented by Chemical Formula 1 includes at least one selected from the group consisting of Ti₂C, V₂C, Nb₂C, Mo₂C, Mo₂N, Ti₂N, (Ti_{2-y}Nb_{y})C (0<y<2), (V_{2-y}Nb_{y})C (0<y<2), (Ti_{2-y}V_{y})C (0<y<2), W_{1.33}C, Nb_{1.33}C, Mo_{1.33}C, Mo_{1.33}Y_{0.67}C, and combinations thereof.

3. The multilayered capacitor of claim 1, wherein
the compound represented by Chemical Formula 1 is a plate-shaped unit Mxene layer, and
the internal electrode includes a Mxene laminate in which one or more unit Mxene layers are stacked.

4. The multilayered capacitor of claim 3, wherein
the internal electrode includes the MXene laminate in which 1 to 500 unit MXene layers are stacked.

5. The multilayered capacitor of claim 1, wherein
an average thickness of the internal electrode is about 0.002 μm to about 2.5 μm.

6. The multilayered capacitor of claim 1, wherein
an average thickness of the dielectric layer is about 0.5 μm to about 3 μm.

7. The multilayered capacitor of claim 1, wherein
the dielectric layer includes a barium titanate-based compound as a main component, and
the barium titanite-based compound includes at least one selected from the group consisting of BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba₁₋ₓCaₓ)ₘ(Ti_{1-y}Sn_{y})O₃ (0.995≤m≤1.010, 0≤x≤0.10, 0<y=0.20), and combinations thereof.

8. The multilayered capacitor of claim 7, wherein
the dielectric layer further includes a subcomponent, and
the subcomponent includes at least one selected from the group consisting of dysprosium (Dy), vanadium (V), manganese (Mn), chromium (Cr), silicon (Si), aluminum (Al), magnesium (Mg), tin (Sn), antimony (Sb), and germanium, (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

9. A multilayered capacitor, comprising
a capacitor body including a dielectric layer and an internal electrode, and an external electrode disposed on an outside surface of the capacitor body,
wherein the internal electrode includes a compound represented by Chemical Formula 1, and
an average thickness of the internal electrode is about 0.002 μm to about 2.5 μm:
Mₙ₊₁Xₙ [Chemical Formula 1]
wherein, in Chemical Formula 1,
M includes at least one selected from the group consisting of Ti, Zr, Hf, Sc, Cr, V, Nb, Ta, Mo, Mn, W, Y, and combinations thereof,
X includes C, N, or a combination thereof, and
1≤n≤2.

10. The multilayered capacitor of claim 9, wherein
the compound represented by Chemical Formula 1 includes at least one selected from the group consisting of Ti₂C, V₂C, Nb₂C, Mo₂C, Mo₂N, Ti₂N, (Ti_{2-y}Nb_{y})C (0<y<2), (V_{2-y}Nb_{y})C (0<y<2), (Ti_{2-y}V_{y})C (0<y<2), W_{1.33}C, Nb_{1.33}C, Mo_{0.33}C, Mo_{1.33}Y_{0.67}C, and combinations thereof.

11. The multilayered capacitor of claim 9, wherein
the compound represented by Chemical Formula 1 is a plate-shaped unit Mxene layer, and
the internal electrode includes a Mxene laminate in which one or more unit Mxene layers are stacked.

12. The multilayered capacitor of claim 11, wherein
the internal electrode includes a MXene laminate in which 1 to 500 unit MXene layers are stacked.

13. The multilayered capacitor of claim 9, wherein
an average thickness of the dielectric layer is about 0.5 μm to about 3 μm.

14. The multilayered capacitor of claim 9, wherein
the dielectric layer includes a barium titanate-based compound as a main component, and
the barium titanite-based compound includes at least one selected from the group consisting of BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x<0.10), (Ba₁₋ₓCaₓ)ₘ(Ti_{1-y}Sn_{y})O₃ (0.995≤m≤1.010, 0≤x≤0.10, 0<y≤0.20), and combinations thereof.

15. The multilayered capacitor of claim 14, wherein
the dielectric layer further includes a subcomponent, and
the subcomponent includes at least one selected from the group consisting of dysprosium (Dy), vanadium (V), manganese (Mn), chromium (Cr), silicon (Si), aluminum (Al), magnesium (Mg), tin (Sn), antimony (Sb), and germanium, (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.
